(19) United States
(12) Patent Application Publication
(10) Pub. No.: US 2018/0159702 A1
(43) Pub. Date: Jun. 7, 2018

(54) PACKET FORWARDING

(71) Applicant: New H3C Technologies Co., Ltd., Zhejiang (CN)

(72) Inventor: Yubing Song, Beijing (CN)

(21) Appl. No.: 15/571,717

(22) PCT Filed: Jun. 24, 2016
(86) PCT No.: PCT/CN2016/086989

§ 371 Date: Nov. 3, 2017

(30) Foreign Application Priority Data
Jun. 26, 2015 (CN) 201510363082.0

(51) Int. Cl. H04L 12/46; H04L 12/931; H04L 12/775; H04L 12/705

(52) U.S. Cl. CPC H04L 12/4666; H04L 45/18; H04L 45/583; H04L 49/354

(57) ABSTRACT

In an example, a method for forwarding packet is applied to a port extender (PE) device within a PE stack system. In a case that the PE device receives a packet from a local ingress port of the PE device, the PE device may determine the local egress port corresponding to the local ingress port by looking up a local forwarding entry according to the local ingress port, and then forward the packet via the local egress port.

### BACKGROUND

In order to satisfy the need of data center, stack networking technology has been proposed. For example, a CB stack system may be constructed by connecting CB (Control Bridge) devices through stack links. A PE (Port Extender) device can connect a CB device and provide a port extension function as a far end interface device of the CB device. A packet received by the PE device can be uplink forwarded to the CB device, and be forwarded by the CB device through looking up a forwarding table. In order to save the uplink from a PE to CB device, multiple independent PE devices can form a PE stack system through stack links. After received by the ingress PE device of the PE stack system, a packet may be forwarded within the PE stack system to be uplink forwarded to the CB device and then the packet may be processed by the CB device and downlink forwarded to the PE stack system. The packet downlink forwarded by the CB device may be forwarded to a destination device through the PE stack system.

The PE stack system can perform packet forwarding with tag encapsulation of the packet. For example, the PE devices supporting the tag encapsulation and with an identical model from an identical manufacture can be stacked.

### BRIEF DESCRIPTION OF THE DRAWINGS

FIG. 1 illustrates a schematic diagram of packet forwarding according to an example of the disclosure;

FIG. 2 illustrates a network structure applied by a method for forwarding packet according to an example of the disclosure;

FIG. 3 schematically illustrates a logical function structure of a PE device according to an example of the disclosure;

FIG. 4 is a flow diagram of a method for forwarding packet according to an example of the disclosure;

FIG. 5 is a flow diagram of a method for forwarding packet according to another example of the disclosure;

FIG. 6 is a flow diagram of entry transforming according to an example of the disclosure;

FIG. 7 schematically illustrates a packet forwarding path according to an example of the disclosure;

FIG. 8 schematically illustrates a packet forwarding path according to an example of the disclosure;

FIG. 9 is a schematic diagram of entry transforming according to an example of the disclosure;

FIG. 10 is a schematic diagram of entry transforming according to an example of the disclosure;

FIG. 11 is a flow diagram of port determining according to an example of the disclosure;

FIG. 12 schematically illustrates the packet forwarding among PE stack systems according to an example of the disclosure;

FIG. 13 is a flow diagram of the packet forwarding among PE stack systems according to an example of the disclosure;

FIG. 14 schematically illustrates the packet forwarding within a PE stack system according to an example of the disclosure;

FIG. 15 is a flow diagram of the packet forwarding within a PE stack system according to an example of the disclosure;

FIG. 16 is a schematic diagram of an annular PE stack system according to an example of the disclosure;

FIG. 17 is a schematic diagram illustrating forwarding of a multicast packet according to an example of the disclosure;

FIG. 18 is a schematic diagram illustrating downlink forwarding of a multicast packet according to an example of the disclosure;

FIG. 19 schematically illustrates downlink forwarding entries of the multicast packet according to an example of the disclosure;

FIG. 20 is a flow diagram schematically illustrating downlink forwarding of the multicast packet according to an example of the disclosure;

FIG. 21 schematically illustrates a hardware structure diagram of a PE device according to an example of the disclosure;

FIG. 22 is a block diagram schematically illustrating function modules of a packet forwarding control logic according to an example of the disclosure;

FIG. 23 is a block diagram schematically illustrating function modules of a packet forwarding control logic according to another example of the disclosure;

### DETAILED DESCRIPTION OF THE EMBODIMENTS

The method for forwarding packet of this disclosure can be applied in a Port Extender (PE) stack system. For example, according to the method for forwarding packet, the PE stack system may uplink forward a packet sent by a source device to a Control Bridge (CB) device, or downlink forward the packet sent by the CB device to a target device. Besides, the packet may be forwarded without tag encapsulation (for example, Higig encapsulation), when forwarding the packet among PE devices of the PE stack system using the method for forwarding packet.

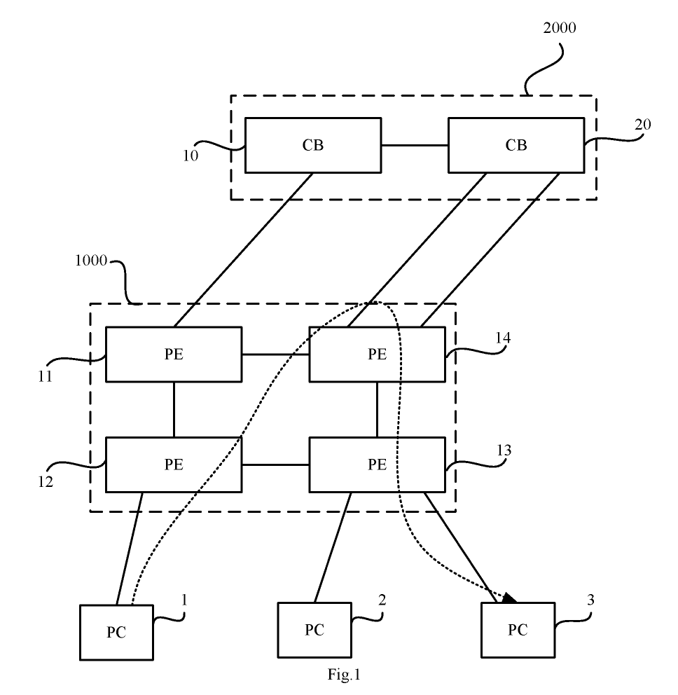

FIG. 1 illustrates a schematic diagram of packet forwarding according to an example. Referring to FIG. 1, PC 1, PC 2 and PC 3 may be used as a source device for sending a packet or a target device for receiving a packet, for example, PC 1 as a source device may send a packet to PC 3 as a destination device. During the process of packet forwarding, it may be to forward a packet by PE stack system 1000 and CB stack system 2000 illustrated in FIG. 1. It also may be to forward a packet by one single CB device with a PE stack system or a CB stack system with one single PE device. Referring to the dotted line with arrow in FIG. 1 (the dotted line with arrow just shows a rough forwarding path of a packet, but does not prescribe a limit to the forwarding devices passed actually), when PC 1 sends a packet to PC 3, PC 1 may send the packet to PE 12 in the PE stack system 1000. Then, through PE 11 in the PE stack system 1000, the packet may be uplink forwarded to CB 10 in the CB stack system 2000, and the CB 10 in the CB stack system 2000 may determine an output port of the packet by looking up the forwarding table. In this situation, the PE device is equal to the extended port of the CB device, and the process of looking up a forward table to forward a packet may be still performed in the CB device. Then, the CB 20 in the CB stack system 2000 may send the packet to the PE stack system 1000 through the output port determined by looking up the forwarding table, and the PE stack system 1000 may send the packet to target device PC 3 via PE 14 and PE 13.

Hereinafter, according to the method for forwarding packet of this disclosure, how to forward a packet within the PE stack system during uplink forwarding the packet to a CB device or downlink forwarding the packet to a PC, will be described.

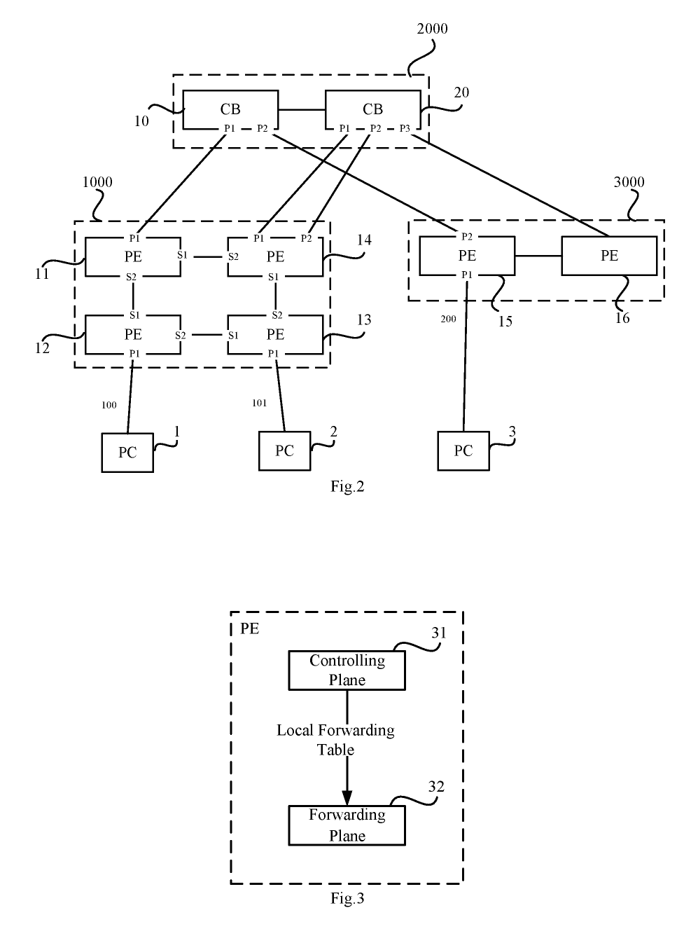

Firstly, referring to FIG. 2, a simplified description is given about the network structure applied by a method for forwarding packet. As shown in FIG. 2, there are two PE stack systems including: a first PE stack system 1000 consisted of PE 11, PE 12, PE 13 and PE 14, and a second PE stack system 3000 consisted of PE 15 and PE 16.

Therein, the PE stack system may be constructed by connecting several PE devices. Take the first PE stack system 1000 as an example, the connection relation among each PE device may be referred to FIG. 2. Each PE device may include several ports, and each port may be assigned with a port number. Wherein, the port used for PE device connection may be called a “stack port”, the port belonging to a PE device but not used for PE device connection may be called a “non-stack port”. Both a stack port and a non-stack port are local ports of the PE device. With respect to one certain PE device, other PE devices may be called “far end PE devices”, the port of a far end PE device may be called a “far end port”. Take PE 12 for example, PE 12 may include ports P1, S1 and S2. Wherein, port P1 is a non-stack port used for connecting PC 1; ports S1 and S2 are stack ports, and port S1 is used for connecting PE 11, and port S2 is used for connecting PE 13. PE 13 may be called a far end PE device of PE 12, and the port S1 of PE 13 is equivalent of a far end port of PE 12.

Besides, a non-stack port of a PE device may connect a PC or CB device, referring to FIG. 2, the port P1 of PE 12 connects PC1, the port P1 of PE 13 connects PC2, the port P1 of PE 15 connects PC3. And, a port of a PE device may be allocated a Port Extended Channel ID (PCID) as a port identifier in a CB-PE longitudinal stack system based on the 802.1BR protocol. For example, the PCID of the port P1 of PE 12 for connecting PC 1 is “100”, the PCID of the port P1 of PE 13 for connecting PC 2 is “101”, the PCID of the port P1 of PE 15 for connecting PC 3 is “200”. The PCID may be set in the E-CID field of the E-tag (Extended tag) in a packet, after the packet is received from a non-stack port of a PE device. The E-tag is used for achieving a centralized forwarding model, which is the tag encapsulated in a packet when CB and PE device exchanging the packet according to the 802.1BR protocol. For example, if the packet carries with the E-CID “100”, it may be determined according to the source port of the packet whether the packet is sent from or to PC 1. For example, if the packet is received from a non-stack port of a PE device, it may be determined according to E-CID “100” carried in the packet that the packet is sent from PC 1. And if the packet is received from a stack port of a PE device, it may be determined whether the stack port has an ACL redirection rule, to be described hereinafter. If the stack port has the ACL redirection rule, the packet may be determined to be uplink sent to the CB device from PC 1 according to E-CID “100” carried in the packet. If the stack port has none ACL redirection rule, the packet may be determined to be sent to PC 1. A PE device may also connect a CB device through a non-stack port. For example, PE 11 may connect the port P1 of CB10 through the port P1 of PE 11; PE 14 may connect the port P1 of CB20 through the port P1 of PE 14, and connect the port P2 of CB20 through the port P2 of PE 14, with the similar principles as the above.

Each PE device may perform packet forwarding with a controlling plane and forwarding plane separated. Referring to the logical function structure of a PE device in FIG. 3, a forwarding table for forwarding a packet may be generated on the controlling plane 31, and packet forwarding may be performed on the forwarding plane 32 based on forwarding entries in the forwarding table. Each PE device in the PE stack system may usually store an identical forwarding table to perform packet forwarding, for example, in order to send unicast packets (uplink or downlink), PE 11-PE 14 in the first PE stack system 1000 store an identical unicast forwarding table. However, in the example, each PE device in the PE stack system can perform entry transformation, to transform the above identical forwarding table into its own local forwarding table including local forwarding entries respectively. Different PE devices may generate different local forwarding entries, and perform packet forwarding according to their own local forwarding entries.

FIG. 4 illustrates a method for forwarding packet performed by single PE device. The method may include the following blocks.

In block 401, a PE device may receive a packet from a local ingress port of the PE device.

In block 402, the PE device may determine a local egress port corresponding to the local ingress port by looking up a stored local forwarding entry according to the local ingress port, and forward the packet through the local egress port.

FIG. 4 illustrates how each PE device in PE stack system performs packet forwarding based on the method for forwarding packet in this disclosure. Besides, seen from the above process, a PE device may perform packet forwarding based on its own stored local forwarding entries. The PE device may determine a local egress port corresponding to the local ingress port by looking up the local forwarding entries according to the local ingress port having received a packet, and forward the packet through the local egress port. Take PE 12 in FIG. 2 as an example, when performing packet forwarding from PC1 to PC2 clockwise, as illustrated in Table 1, PE 12 may send out a packet received from local ingress port P1 through local egress port S1 according to the local forwarding entry.

TABLE 1
Local forwarding table of PE 12

| Position | Action | Physical egress port |
|---|---|---|
| P1 | Port redirection | S1 |

Seen from above, in this method, the PE device may perform packet forwarding based on the local forwarding table. Thus, in case that a packet is not tag-encapsulated, the PE device may encapsulate the packet into a 802.1BR packet, and then forward the 802.1BR packet by looking up local forwarding entries in the local forwarding table which is transformed from a pre-stored unified stack forwarding table. This can get rid of dependence of tag-encapsulation, and improve the flexibility of choosing a PE device in PE stack system.

In another example, when a PE device performs packet forwarding based on a local forwarding table, if its local ingress port having received a packet is a non-stack port, then as the method illustrated in FIG. 4, the PE device may perform packet forwarding by looking up the local forwarding table according to the local ingress port. If the local ingress port having received the packet is a stack port, then in order to perform packet forwarding more precisely, the PE device can perform packet forwarding based on the local ingress port and an extension channel identifier (E-CID).

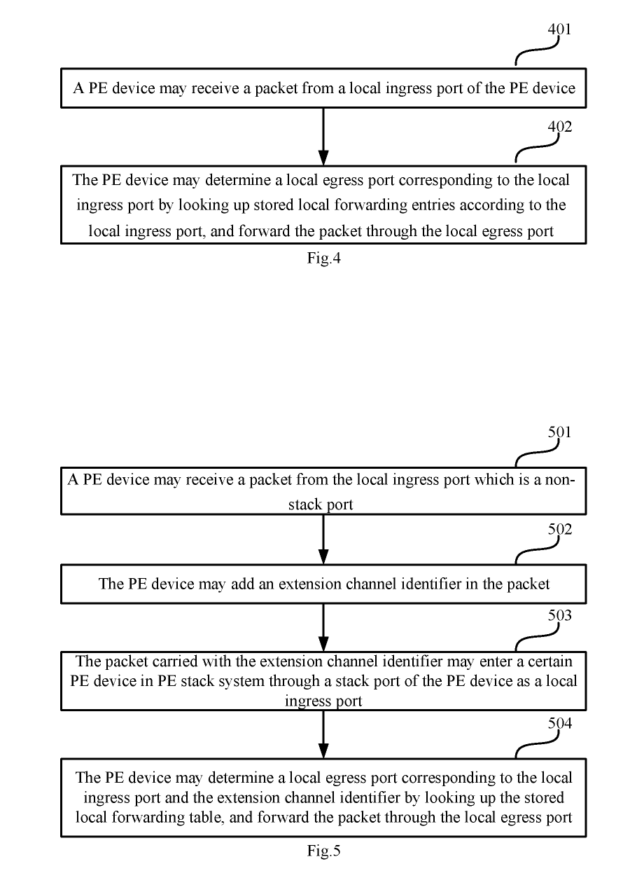

For example, referring to the flow diagram of FIG. 5, in block 501, when the local ingress port of a packet received by a PE device is a non-stack port such as the port P1 of PE 11 or PE 12 in FIG. 2, then the PE device may add an extension channel identifier E-CID in the packet in block 502. In block 503, the packet carrying the E-CID may go through a stack port of a certain PE device in PE stack system as a local ingress port, into the PE device. Then in block 504, the PE device may determine a local egress port corresponding to the local ingress port and the E-CID carried in the packet by looking up the stored local forwarding table according to the local ingress port and the E-CID, and may forward the packet through the local egress port.

Besides, the local forwarding table can be obtained by each PE device performing entry transformation for the stack forwarding entries in the stack forwarding table, which is the identical forwarding table stored in each PE device of the PE stack system as mentioned above. The stack forwarding entry may usually include destination port information indicating a destination port (namely from which port of the PE stack system to send out the packet). The destination port may locate on a certain PE device of the PE stack system, and is a local port with respect to the PE device, yet a far end port to other PE devices. In this block, each PE device may need to parse the stack forwarding entries to transform them into its own local forwarding entries, which are the basis for the PE device performing packet forwarding, and the local forwarding entries may include the local ports of the PE device.

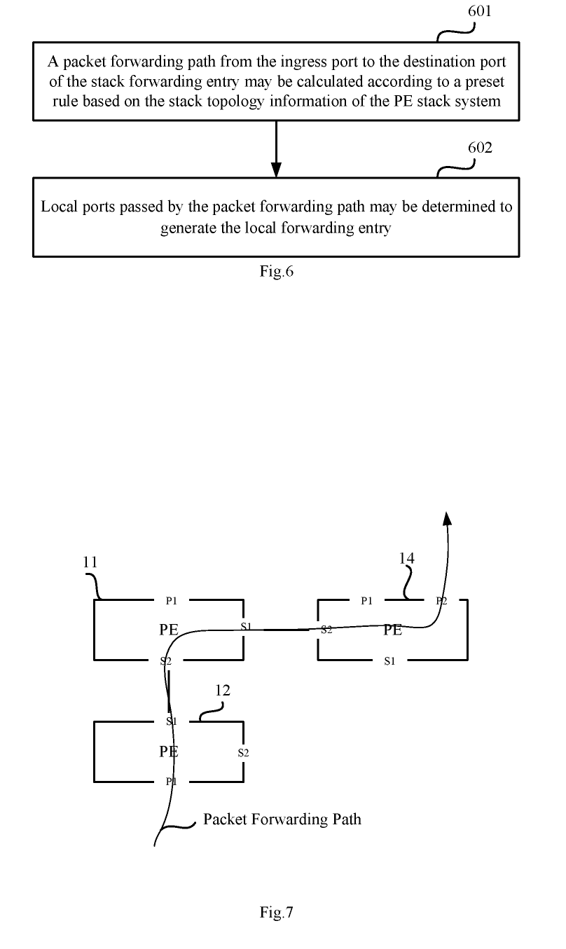

The PE device can perform entry transformation to acquire the local forwarding entries according to the process illustrated in FIG. 6, which includes following blocks.

In block 601, a packet forwarding path from the ingress port to the destination port of the stack forwarding entry may be calculated according to a preset rule based on the stack topology information of the PE stack system.

In block 602, local ports passed by the packet forwarding path may be determined to generate the local forwarding entry.

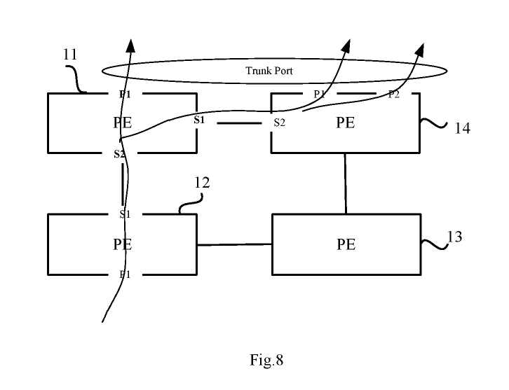

In combination with FIG. 6 and FIG. 7, the following will describe the principle of entry transformation. Suppose that the stack forwarding entry specifies the ingress port is the port P1 of PE 12, and the egress port is the port P2 of PE 14. When performing entry transformation, a PE device can calculate the path from an ingress port to an egress port based on the ingress port, the egress port and the stack topology information. The stack topology information means the connections between each PE device of the PE stack system (for example, through the stack port S1, PE 12 connects to the stack port S2 of PE 11), and is known to every PE device. On such basis, every PE device may employ an identical internal routing algorithm, to calculate the packet forwarding path from the ingress port to the egress port of the stack forwarding entry. Due to the identical routing algorithm employed, each PE device may obtain the same path. For example, as illustrated in FIG. 7, with the port P1 of PE 12 being the ingress port and the port P2 of PE 14 being the egress port, the path may be: the port P1 of PE 12-the port S1 of PE 12-the port S2 of PE 11-the port S1 of PE 11-the port S2 of PE 14-the port P2 of PE 14.

Take PE 11 as an example, according to the path calculated above, PE 11 can know that, a packet enters PE 11 from its port S2, and exits PE 11 from port S1, namely the local ports passed by the packet forwarding path are S2 and S1. Thereby, the local forwarding entry generated by PE 11 can include the ingress port S2 and the egress port S1. For example, the entry distributing position included in the entry may be the ingress port S2, and the local egress port for forwarding a packet may be S1. PE 11 may distribute the entry used to redirect a packet, to the ingress port S2. The distributed entry may instruct the ingress port S2 “to send out a packet through the egress port S1, when receiving the packet which satisfies a condition such as matching E-CID”.

Regardless of the uplink or downlink forwarding of a packet, the principles of entry transformation are the same, that is, to find out the local ports passed by the packet forwarding path by path calculation, to generate the local forwarding entry including the local ports, thus each PE device can perform packet forwarding based on its own local forwarding entry.

In the tag encapsulation, information such as the source address and the destination address of a packet may be encapsulated in the tag, each PE device may acquire the information such as the destination address to forward the packet only by parsing the tag in the packet. If the tag encapsulation of the packet uses a different technology or even not supported by the PE device, then the packet cannot be forwarded. However, in an example of this disclosure, each PE device may forward a packet according to the local forwarding entry even without tag encapsulation. This is equivalent to that each PE device may just take charge of the packet forwarding by itself, and the packet may finally be sent out of the PE stack system by forwarding of each PE device in succession.

PE devices may perform packet transmitting to each other directly according to the 802.1BR protocol without the tag encapsulation, which extends the flexibility of choosing a PE device enormously. For example, PE devices from different chip producers may stack with each other, or PE devices from different chips of the same chip producer may stack with each other. Even a device not supporting tag encapsulation may also participate in the PE stacking, therefore the networking of PE stack system may be more flexible while reducing the cost of networking.

As follows, take the situations of uplink or downlink forwarding a unicast or multicast packet as examples, how a PE device to perform entry transformation according to the method for forwarding packet of this disclosure is detailed with reference to the network structure illustrated in FIG. 2.

In case of uplink forwarding a unicast packet, the PE stack system may forward the unicast packet sent by PC to a CB device. For example, if PC 1 sends a packet to PC 3, PC 1 may send the packet to the first PE stack system 1000 firstly, and the first PE stack system 1000 uplink send the packet to a CB device in the CB stack system 2000.

PE 11-PE 14 in the first PE stack system 1000 may all store a same stack forwarding table, as illustrated in Table 2. Seeing the first entry in the table, the entry specifies the redirection rule distributed to the port P1 of the PE 12, and assigns the destination egress port of the packet as a trunk port, including the port P1 of PE 11, and the ports P1 and P2 of PE 14. In other words, if a matching packet is received through the port P1 of PE 12, it can be sent out of the PE stack system though the port P1 of PE 11, or the port P1 or P2 of PE 14.

TABLE 2
Stack Forwarding Table

| Position | Action | Physical egress port |
|---|---|---|
| PE 12/P1 | Port | Trunk Port (PE 11/P1, PE 14/P1, PE 14/P2) |
| | redirection | |
| PE 13/P1 | Port | Trunk Port (PE 11/P1, PE 14/P1, PE 14/P2) |
| | redirection | |

Take the first entry in Table 2 as an example, how each PE device transforms the stack forwarding entry into its own local forwarding entry will be described. On the controlling plane, PE 11 may calculate the path from the ingress port to the egress port of a packet by internal routing algorithm such as shortest path routing algorithm, according to the ingress port and the egress port of the packet and the stack topology information of the PE stack system. For example, the calculated path from the ingress port P1 of PE 12 to the physical egress port “Trunk Port (PE 11/P1, PE 14/P1, PE 14/P2)” may be as illustrated in FIG. 8. PE 11 may determine that the local ports on the path include: the local ingress port for receiving a packet (the stack port S2), and the local egress ports for sending a packet (the local port P1 and the stack port S1).

According to the acquired local ports as mentioned above, PE 11 may learn that the distribution position of the redirection rule is the stack port S2 for receiving a packet, and the destination ports of the packet are the local port P1 and the stack port S1 used as a trunk port. This is due to that in macro view, multiple trunk links may exist between the PE stack system and the CB device, and in order to share the flow evenly on each of the trunk links, the destination port may be a trunk port including several ports. Thus, the packet may be sent through any of the ports in the trunk port. For example, the packet may be sent through any one of the ports in the trunk port selected by Hash algorithm. Thus, the local forwarding table of PE 11 may be acquired as follows:

TABLE 3
Local Forwarding Table of PE 11

| Position | Action | Physical egress port |
|---|---|---|
| S2 | ACL redirection | Trunk (P1, S1) |
| | (matching E-CID 100) | |

As illustrated in Table 3, PE 11 may distribute the redirection rule to the ingress port S2 (command distributing position) based on the local forwarding table, indicating that the local egress port is “Trunk (P1, S1)”. Wherein, the redirection rule may be an ACL (Access Control List) redirection rule, because the local ingress port S2 to which the rule is distributed is a stack port used for PE connections. The flow passing through the stack port may come from multiple different devices, for example, the flow passing through the stack port S2 not only come from the flow of PC 1 but also flow of other devices, such as the packets sent out from PC 2 arriving at PE 11 via PE 13 and PE 12. Therefore, the packet matching of the stack port may include two aspects, namely, to match the port number of the local port for receiving a packet and to match the E-CID (Extended-Channel Identifier) field carried in the E-tag in the packet. According to Table 3, the packet should satisfy the condition “enter from the port S2 of PE 11, with the E-CID field carried in the E-tag is 100 (namely the packet is a packet received from the port of PE 12, whose PCID is 100)”. PE 11 can distribute the ACL redirection rule to its local stack port S2 based on the entry in Table 3. If the packet received by PE 11 satisfies the condition of matching the ingress port S2 and the E-CID 100 of the packet, then PE 11 may send the packet to the local ports P1 and S1.

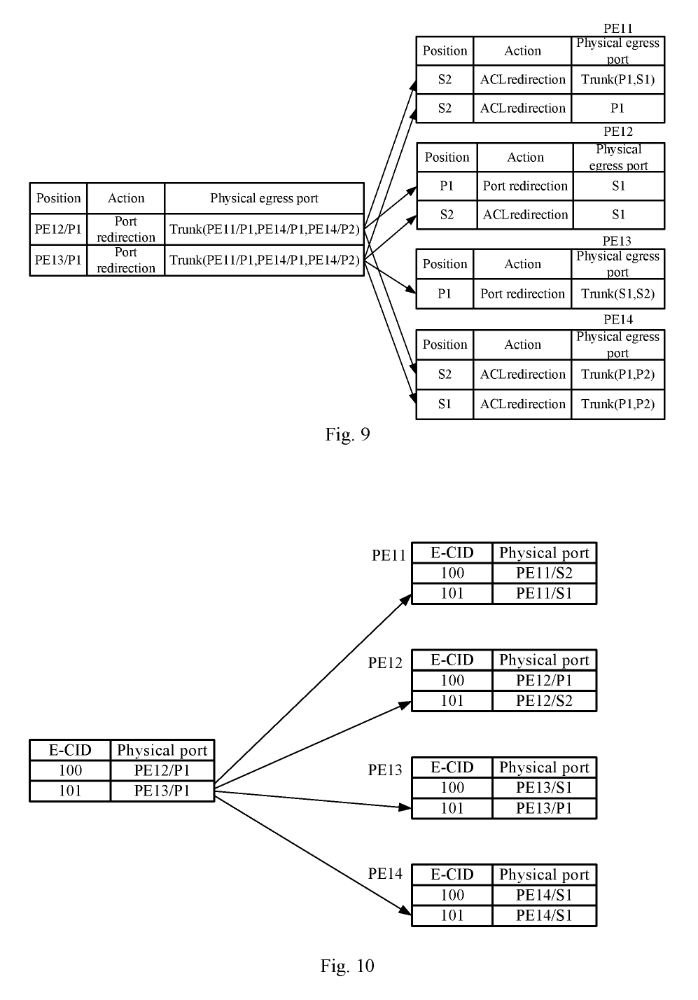

The above is to take the PE 11 as an example, to explain how PE 11 transforms the entry “the PE 12/P1, the port redirection, Trunk Port (PE 11/P1, PE 14/P1, PE 14/P2)” in Table 2 into the local forwarding entry of PE 11 illustrated in Table 3. PE 11 may distribute the ACL redirection rule to the local port S2 based on the entry, to indicate packet forwarding on PE 11. Other PE devices (such as PE 12, PE 13 and PE 14) have the same transformation method of Table 2 as PE 11, needless to repeat, but illustrated in FIG. 9 is the corresponding relationship of the entry transformation, in which the corresponding local forwarding entries transformed by each PE device from the stack forwarding entries respectively are illustrated.

Wherein, it should be noted that what is distributed to the non-stack port of the PE device is the “port redirection rule”, and comparing with the “ACL redirection rule”, the “port redirection rule” only demands that the packet match the ingress port. For example, take PE 12 as an example, a packet may enter from the local port P1 of PE 12 and exit from the local port S1 of PE 12 based on the packet forwarding path illustrated in FIG. 8. Then the command distributing position of PE 12 is P1 being a non-stack port, so it is sufficient to employ the port redirection rule. That is to say, as long as the packet enters from the port P1, the corresponding egress port is S1. The details may refer to the local forwarding entry corresponding to the first entry of the stack forwarding table on PE 12 in FIG. 9.

In case of downlink forwarding a unicast packet, after the PE stack system uplink forwards the unicast packet sent by PC to a CB device, the CB device may still send the packet back to the PE stack system after looking for the forwarding table. The packet may finally be sent to the destination device (such as PC 3) by the PE stack system. Thus, downlink forwarding a unicast packet means that the PE stack system forwards the packet sent by the CB device to PC.

As illustrated in FIG. 10, in case of downlink forwarding a unicast packet, the stack forwarding entry may be transformed to the corresponding local forwarding entry on each PE device, the principle of entry transformation is similar with that in case of uplink forwarding a unicast packet, here needless to repeat. According to the position indicated by the E-CID attribute value together with the shortest path routing algorithm of the PE stack system, the passed-by PE devices and their ports when downlink forwarding a packet may be determined.

Referring to FIG. 10, take the second entry (101, PE 13/P1) of the stack forwarding table as an example, the entry transformation is described in combination with the network structure illustrated in FIG. 2. For example, the position that E-CID 101 indicates is the port P1 of PE 13, if PE 11 wants to address to the position that E-CID 101 indicates, one of the two paths PE 11-PE 14-PE 13 and PE 11-PE 12-PE 13 may be chosen according to the routing algorithm. Suppose that the routing algorithm of every PE device chooses the clockwise path, namely PE 11-PE 14-PE 13, then for the packet the egress port on PE 11 is the port S1 thereof, the egress port on PE 14 is the port S1 thereof, the egress port on PE 13 is the port P1 thereof. Yet the shortest path from PE 12 to the position that E-CID 101 indicates can only be via the port S2 of PE 12 to PE 13 directly, so for the packet the egress port on PE 12 is PE 12/S2. It can be seen that, in the entry transformation in case of downlink forwarding a unicast packet, every PE device may calculate the path from the ingress port to egress port in the stack forwarding table respectively, to determine the local egress port that the path passes by. And a received packet may be sent out via the determined local egress port.

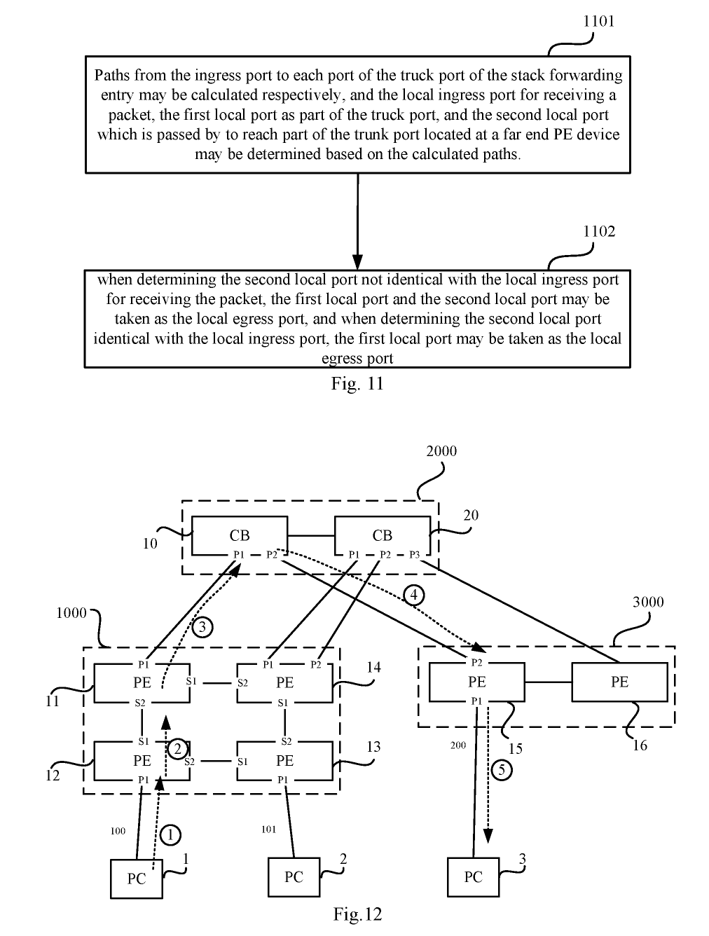

Besides, in the process of the entry transformation, if the destination port in the stack forwarding entry is a Truck Port, then the local ports, which the packet forwarding path passes by, may be determined according to the process in FIG. 11.

In block 1101, the paths from the ingress port to each port of the truck port of the stack forwarding table may be calculated respectively. And the local ingress port for receiving a packet, the first local port as part of the truck port, and the second local port which is passed by to reach part of the trunk port located at a far end PE device may be determined based on the calculated paths.

For example, still in combination with the illustration in FIG. 8, the destination port of the stack forwarding entry, i.e. the egress port, is the trunk port, then when determining the local egress ports, PE 11 may calculate the paths from the ingress port to each port in the trunk port in the stack forwarding entry. According to the calculated paths, the port P1 of PE 11 may be determined as the first local port, the port S1 of PE 11 may be determined as the second local port which is passed by to reach the part of the truck port located at the far end PE device, i.e. PE 14. But with respect to PE 14, the determined first local port is P1 and P2 of PE 14, but the second local port is S2 of PE 14.

In block 1102, when determining the second local port not identical with the local ingress port for receiving the packet, the first local port and the second local port may be taken as the local egress port. When determining the second local port identical with the local ingress port, the first local port may be taken as the local egress port.

For example, with respect to PE 11, the packet enters PE 11 from the port S2 thereof, that means the local ingress port of PE 11 is S2, while the second local port is S1. It can be seen that, the second local port is not identical with the local ingress port, then PE 11 may take the ports P1 and S1 as the local egress port. With respect to PE 14, the packet enters from the port S2 of PE 14, that means the local ingress port of PE 14 is S2, while the second local port of PE 14 is also S2, then the second local port is identical with the local ingress port. Therefore PE 14 may take the ports P1 and P2 as the local egress ports, instead of taking the port S2 as the local egress port.

Based the above description for “entry transforming” in cases of uplink or downlink forwarding a unicast packet, the following will describe the process of the PE stack system forwarding a unicast packet according to the local forwarding entries acquired after each PE device performing the entry transformation, as shown in FIG. 9 and FIG. 10. The description may take the unicast packet forwarding among PE stack systems and unicast packet forwarding within a PE stack system respectively as examples.

Referring to FIG. 12, the packet forwarding path is shown with dotted line with the arrow, and each forwarding process block on the path is shown with number in a circle in FIG. 12. Besides, because FIG. 12 illustrates the packet forwarding among PE stack systems that PC 1 sends packets to PC 3, it is needed according to the local forwarding table on PE 15 is also needed.

TABLE 3
Local Forwarding Table of PE 15

| E-CID | Physical egress port |
|---|---|
| 200 | PE 15/P1 |

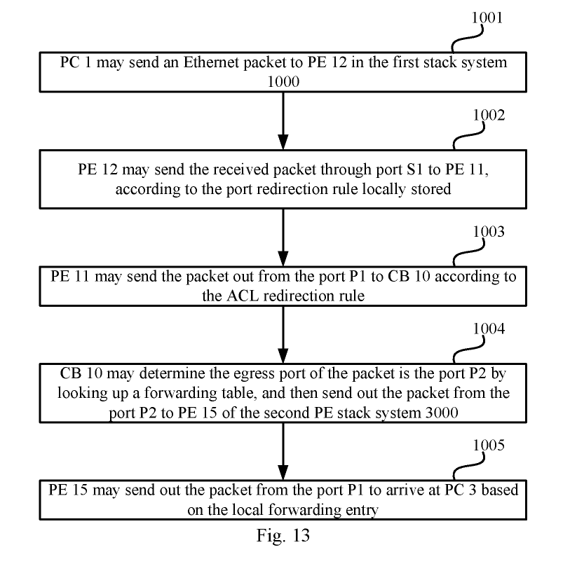

The blocks of the packet forwarding among PE stack systems in FIG. 12 are illustrated in FIG. 13, including the following blocks 1001-1005.

In block 1001, PC 1 may send an Ethernet packet to PE 12 in the first stack system 1000.

Wherein, the packet carries the MAC address of the destination device PC 3, and the Ethernet packet sent by PC 1 enters the first PE stack system from the port P1 of PE 12.

In block 1002, PE 12 may send the received packet through port S1 to PE 11, according to the port redirection rule locally stored.

Wherein, PE 12 may encapsulate the received packet sent by PC 1 into an 802.1BR packet without Hig tag, and fill the PCID 100 assigned for the port P1 of PE 12 in the E-CID field of the packet, and fill 0 in the ingress E-CID field of the packet. PE 12 may also fill 0 in the E-CID field and fill 100 in the ingress E-CID field, according to the specific chip.

Besides, as described above, PE 12 may distribute the port redirection rule to its local port P1. With reference to the first entry on PE 12 of FIG. 9, as long as the received packet matches the ingress port (enters from the port P1), the packet may be sent out from the stack port S1. Then PE 12 may send the packet out from the stack port S1 according to the port redirection rule.

In block 1003, PE 11 may send the packet out from the port P1 to CB 10 according to the ACL redirection rule.

Wherein, PE 11 has already distributed the ACL redirection rule to the local stack port S2 based on its local forwarding entry. As long as the packet enters PE 11 from the port S2, and the E-CID in E-tag of the packet is 100, the packet may be sent out from Trunk (P1, S1). In this block, PE 11 may receive the 802.1BR packet sent from PE 12, determine that the packet hits the ACL redirection rule and the local egress port is a trunk port. Then PE 11 may choose one port from the trunk port randomly to send out the packet (namely PE 11 may send out the packet from one port of the trunk port), suppose that in this example PE 11 sends out the packet from the local port P1, upward to CB 10.

In block 1004, CB 10 may determine the egress port of the packet is the port P2 by looking up a forwarding table, and then send out the packet from the port P2 to PE 15 of the second PE stack system 3000.

Wherein, with respect to the received packet, by looking up a forwarding table based on the combination of DMAC (Destination Media Access Control) address and VLAN (Virtual Local Area Network), CB 10 may learn that the destination E-CID is 200, and that the corresponding local egress port is P2. Then the attribution value 200 of E-CID may be filled into the E-CID field in the E-tag of the packet to replace the original E-CID 100, the ingress E-CID field may be still filled with 0, and the packet may be sent out from the port P2. After sent out from the port P2 of CB 10, the packet arrives at PE 15 of the second PE stack system 3000, to enter the second PE stack system 3000 through the port P2 of PE 15.

In block 1005, PE 15 may send out the packet from the port P1 to arrive at PC 3 based on the local forwarding entry.

Wherein, PE 15 may learn that the local egress port corresponding to the packet of E-CID 200 is PE 15/P1 based on the local forwarding entry illustrated in Table. 3, then the packet may be sent out from the port P1 after removing the E-tag.

Eventually, PC 3 may receive the packet. The packet sent out from PC 1 may pass by the first PE stack system 1000, CB stack system 2000, the second PE stack system 3000, to arrive at the destination device PC 3. And it can be seen from the process illustrated in FIG. 13 that, in the process of packet forwarding, every PE device in the PE stack system may perform packet forwarding based on the local forwarding entry.

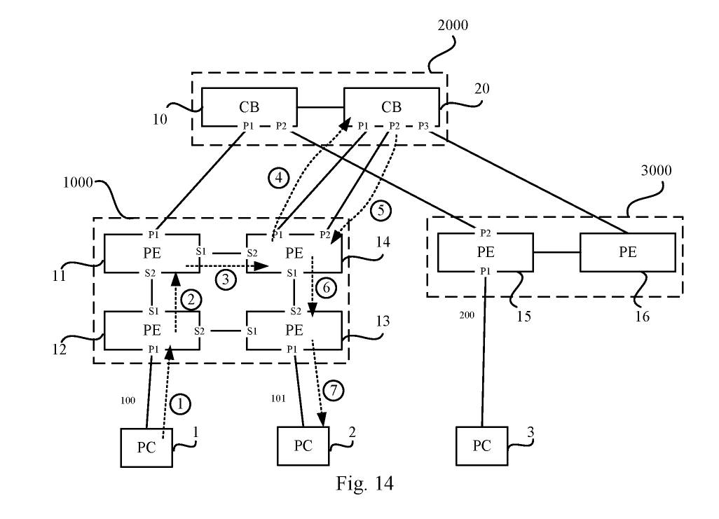

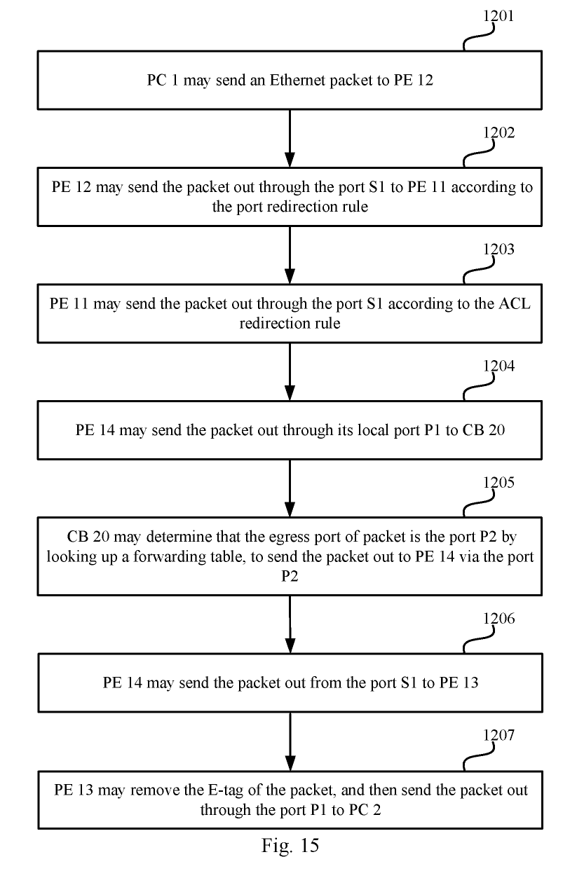

FIG. 14 illustrates the packet forwarding within a PE stack system, namely the packet forwarding based on the path of the same one PE stack system, such as PC1 sends the packets to PC2. Also, every PE device in the PE stack system may still perform packet forwarding based on the local forwarding entries transformed in FIG. 9 and FIG. 10. FIG. 15 illustrates the process of the packet forwarding within a PE stack system, including the following blocks.

In block 1201, PC 1 may send an Ethernet packet to PE 12.

Wherein, the Ethernet packet sent by PC 1 carries with the MAC address of the destination device PC 2, and may enter the first PE stack system 1000 through the port P1 of PE 12.

In block 1202, PE 12 may send the packet out through the port S1 to PE 11 according to the port redirection rule.

Wherein, PE 12 may encapsulate the received packet sent by PC 1 into an 802.1BR packet without Hig tag, and fill the port identifier “100” in E-CID field of the packet, and fill 0 in ingress E-CID field of the packet.

Besides, as described above, PE 12 may distribute the port redirection rule to its local port P1. As long as the received packet matches the ingress port (enters from the port P1), the packet may be sent out through the stack port S1, with reference to the first entry on PE 12 of FIG. 9. Then PE 12 may send the packet out through the stack port S1 according to the port redirection rule.

In block 1203, PE 11 may send the packet out through the port S1 according to the ACL redirection rule.

Wherein, according to its local forwarding entries, PE 11 has already distributed the ACL redirection rule to the local stack port S2. As long as the packet enters PE 11 through the port S2, and the E-CID of the E-tag in the packet is 100, then the packet may be sent out from Trunk (P1, S1).

In this block, PE 11 may receive the 802.1 BR packet sent from PE 12, and determine that the received packet hits the ACL redirection rule, and the local egress port is a trunk port. Then PE 11 may send the packet out through a port chosen randomly from the trunk port (i.e. the packet may be sent out through one port from the trunk port), suppose PE 11 sends out the packet through the local port S1 to PE 14 in this example.

In block 1204, PE 14 may send the packet out through its local port P1 to CB 20.

Wherein, after receiving the packet via the stack port S2, PE 14 may also perform ACL redirection to determine that the local egress port of the packet is Trunk (P1, P2). Then PE 14 may send the packet out through a randomly chosen port such as P1, and the packet arrives at CB 20.

In block 1205, CB 20 may determine that the egress port of packet is the port P2 by looking up a forwarding table, to send the packet out to PE 14 via the port P2.

Wherein, with regard to the received packet, CB 20 may acquire that the destination E-CID is 101, and the corresponding local egress port is a trunk port by looking up a forwarding table in the way of DMAC+VLAN. Suppose CB 20 fills the attribution value 101 of E-CID in E-CID field of the E-tag of the packet to replace the original E-CID 100, and chooses the port P2 randomly to send out the packet to arrive at PE 14 of the first PE stack system 1000. Wherein, in order to realize source filtering, meaning that the sending source filters the packet sent by itself (e.g. the broadcast packet sent by itself cannot be received any more), PCID value assigned for the source port may be filled in the ingress E-CID field for carrying source channel information, e.g. filling 100 in ingress E-CID field.

In block 1206, PE 14 may send the packet out from the port S1 to PE 13.

Wherein, in combination with the forwarding entries of PE 14 in FIG. 10, PE 14 may send the packet whose E-CID is 101 out through the port S1 to PE 13.

In block 1207, PE 13 may remove the E-tag of the packet and send the packet out through the port P1 to PC 2.

Wherein, in combination with the forwarding entries of PE 13 in FIG. 10, PE 13 may send out the packet whose E-CID is 101 through the port P1, and then the packet arrives at the destination device PC2.

When the packet is a multicast packet (or broadcast packet), the uplink forwarding process of sending the packet to a CB device is similar to the principle of uplink forwarding a unicast packet, needless to repeat, but multicast packet forwarding differs from unicast packet forwarding in downlink forwarding.

Take the multicast packet forwarding in case of circle stacking for instance, when the multicast packet enters the ingress PE device of the PE stack system, the ingress PE device may send out the packet through the local egress ports on both clockwise and counter clockwise directions. In order to avoid forming a packet transmission loop, other PE devices may conform to the following forwarding rule of stack port. That is, allowing the forwarding of the packet with the shortest transmission path, not allowing the forwarding of the packet not with the shortest transmission path, and only choosing one path from the equivalent paths.

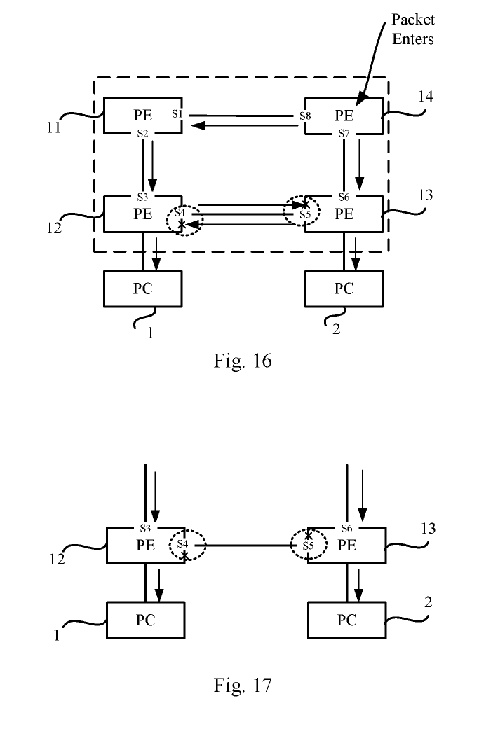

For example, referring to the illustration of FIG. 16, PE 14, PE 13, PE 12 and PE 11 may form a circle PE stack system, the multicast packet may enter the PE stack system from PE 14, suppose that the multicast addresses of the packet include multiple destination PCs, among which two destination PCs are PC 1 and PC 2. PE 14 may send out the packet through the local ports S7 and S8 on clockwise and counter clockwise directions, respectively. Based on the above forwarding rule of stack port, when receiving the packets from the ports S3 and S4, PE 12 determines the distances between the port S3 and port S4 with the ingress PE 14 are the same (both are two hops). Thus PE 12 may choose to forward the packets from one of the two ports and the packets from the other port may be blocked, in order to avoid reduplicate sending of the packet. For example, PE 12 can forward the packet received counter clockwise from the port S3 to PC 1, but with respect to the packets received clockwise from the port S4, PE 12 may block them and cease to send out, which means they are blocked in the port S4 of PE 12 in the clockwise direction. In the same way, with respect to PE 13, the transmission path of the packets received from the port S6 is the shortest path, therefore PE 13 may forward the packets to PC 2. But the transmission path of the packets received from the port S5 on counter clockwise direction is not the shortest path from PE 14, therefore the packets received from the port S5 of PE 13 are blocked.

Corresponding to the process illustrated in FIG. 16, FIG. 17 illustrates the method for forwarding a multicast packet of this disclosure, that is, the packets are not blocked at the ingress ports of the PE device receiving the packets, but are blocked directly at the egress ports of the PE device sending out the packets. For example, in FIG. 16, PE 12 may send out the packets from the stack port S4 to PE 13 on counter clockwise direction, and PE 13 may block the packets and cease to send out them in the stack port S5 receiving the packets. But in FIG. 17, PE 12 may cease to send out the packets from the stack port S4 and may block the packets directly in the local port. In the same way, in FIG. 16, the packets sent from the stack port S5 of PE 13 to the stack port S4 of PE 12 clockwise may be blocked in the stack port S4 of PE 12. But in FIG. 17, the packets may be blocked directly in the local stack port S5 of PE 13 and will not be sent to PE 12. And on which port of the PE device the packet is to be blocked, can be determined based on the block algorithm of stack multicast.

In summary, when a PE device generates a multicast forwarding table based on the packet forwarding path, it may also generate a local block port for blocking loop flow according to the blocking algorithm of stack multicast, and delete the local block port from the local egress ports in the local forwarding entries.

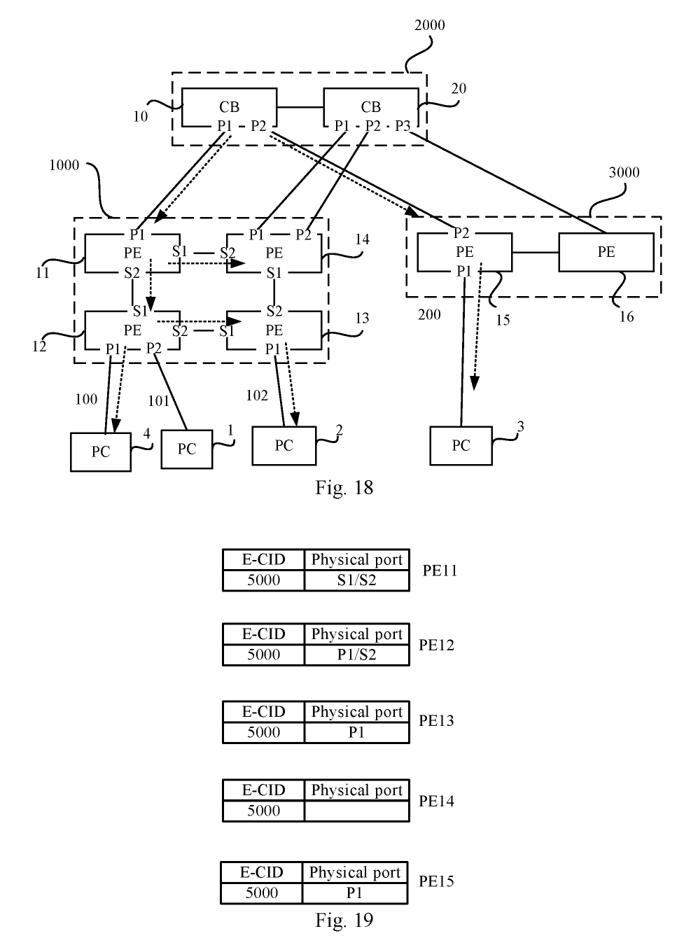

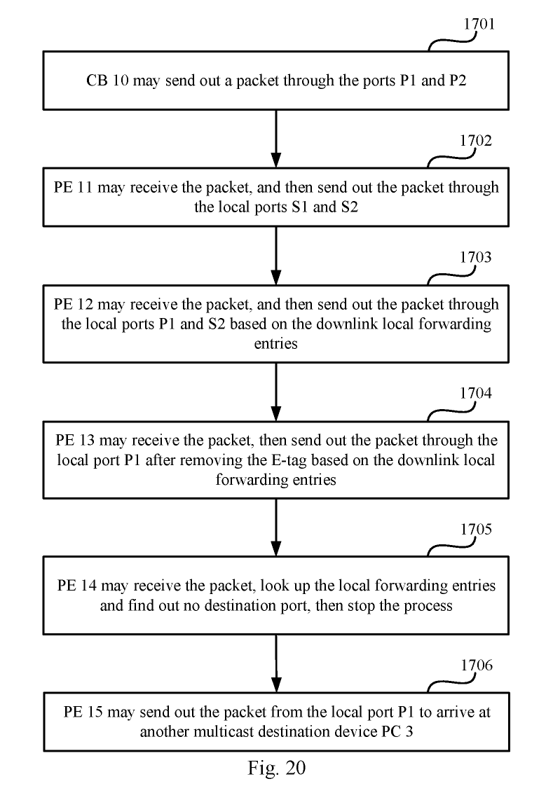

In combination with FIG. 18, the downlink forwarding of the multicast packet is illustrated, suppose that PC 1 is the source device, PC 2, PC 3 and PC 4 are the destination devices, and that group E-CID is 5000. FIG. 19 also illustrates the forwarding entries of the multicast downlink on every PE device, in combination with the process of FIG. 20, the process of downlink forwarding a multicast packet by the PE device in the PE stack system based on the entries in FIG. 19 is described.

In block 1701, CB 10 may send out a packet through the ports P1 and P2.

Wherein, suppose that CB 10 determines that the multicast packet may arrive at the destination device via the egress ports P1 and P2 by looking up the local forwarding entries, then CB 10 may fill 5000 in the E-CID field of the packet. The packet may be sent through the egress port P1 of CB 10 to arrive at the first PE stack system 1000, and PE 11 may be taken as the ingress PE device. The packet may be sent through the egress port P2 of CB 10 to arrive at the second PE stack system 3000, and PE 15 may be taken as the ingress PE device.

In block 1702, PE 11 may receive the packet, and then send out the packet through the local ports S1 and S2.

In block 1703, PE 12 may receive the packet, and then send out the packet through the local ports P1 and S2 based on the downlink forwarding entries illustrated in FIG. 19; wherein, the packet sent from the port P1 may arrive at PC 4, being one of the multicast destination devices.

In block 1704, PE 13 may receive the packet, then send out the packet through the local port P1 after removing the E-tag based on the downlink forwarding entries illustrated in FIG. 19, and the packet may arrive at another multicast destination device PC 2.

It should be noted that, PE 13 has already determined that the local block port is the stack port S2 according to the blocking algorithm of the stack multicast. Therefore, after receiving the packet sent from PE 12, PE 13 will not continue sending the packet through the stack port S2 to PE 14, the packet may be blocked at the stack port S2 of the PE 13 on counter clockwise direction. The stack port S2 of PE 13 is not included in the egress ports of the entries in FIG. 19.

In block 1705, PE 14 may receive the packet, look up the local forwarding entries and find out no destination port, then stop the process.

Wherein, the packet that PE 14 received may be sent by PE 11 on clockwise direction, and PE 14 has also already determined the local block port is the stack port S1 according to the blocking algorithm of the stack multicast. Therefore, the egress port in entry of PE 14 in FIG. 19 does not include the stack port S1, then PE 14 may block the packet at the local port S1 on clockwise direction, instead of sending it to PE 13 continually.

In block 1706, PE 15 may send out the packet from the local port P1 to arrive at another multicast destination device PC 3.

Besides, when the stack topology of the PE stack system has changed, or the ports of PE devices have changed (for example, the port connecting a PE and CB device, or a stack port for connection among PE devices has changed), each PE device may acquire the updated stack topology information, and recalculate the local port according to the updated stack topology information, to update the local forwarding entries for forwarding packet. Besides, the stack port in this disclosure is another kind of port without direction, instead of cascade port/upstream port/extended port defined by the 802.1BR protocol.

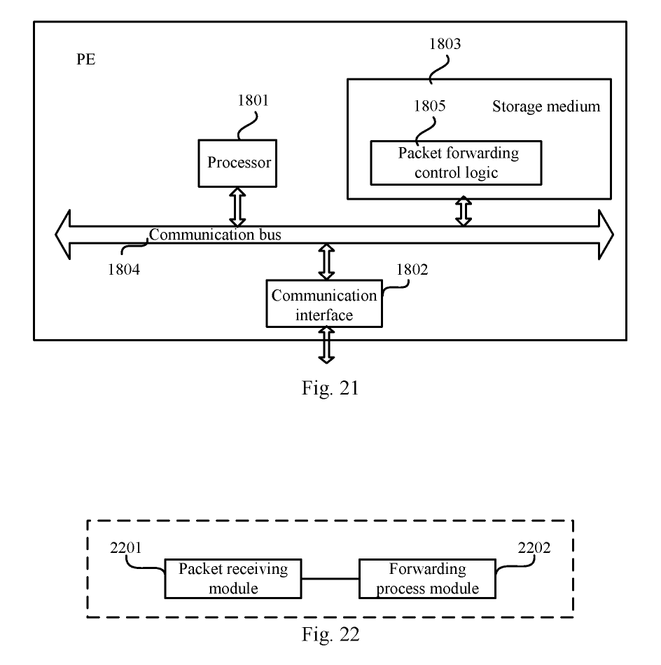

A PE device is illustrated in FIG. 21, the PE device may include a processor 1801, communication interface 1802, storage medium 1803, and communication bus 1804. The processor 1801, communication interface 1802, and storage medium 1803 may communicate with each other by communication bus 1804. The communication interface 1802 may communicate with network elements such as other PE devices. The processor 1801 may invoke machine executable instructions 1805 stored in storage medium 1803. The processor 1801 can be a central process unit (CPU). The storage medium 1803 can be a non-volatile memory for example.

The machine executable instructions 1805 may correspond to the packet forwarding control logic, and logically be divided into the function modules as illustrated in FIG. 22, including packet receiving module 2201 and forwarding process module 2202. The PE device may perform the packet forwarding by the processor executing machine executable instructions. Wherein, the packet receiving module 2201 can receive a packet from a local ingress port. By looking up the stored local forwarding entry, the forwarding process module 2202 can determine the local egress port corresponding to the local ingress port, and forward the packet via the local egress port.

In another example, if the local ingress port is a non-stack port, packet receiving module 2201 can add an extension channel identifier into the packet after receiving the packet from the local ingress port. If the local ingress port is a stack port, forwarding process module 2202 can determine the local egress port corresponding to the local ingress port and the extension channel identifier carried in the packet by looking up the stored local forwarding entry based on the local ingress port and the extension channel identifier. And forwarding process module 2202 may forward the packet via the local egress port.

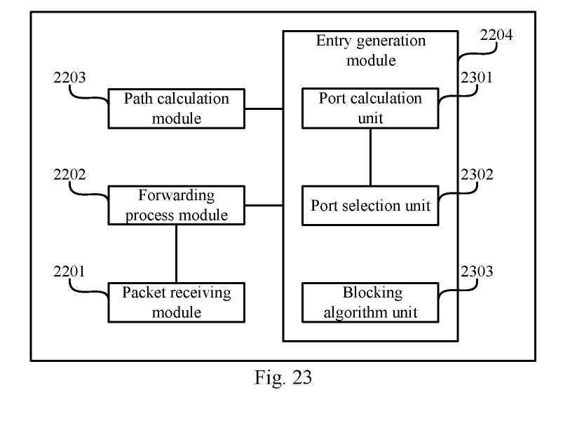

FIG. 23 illustrates function modules of a packet forwarding control logic according to another example of the disclosure. In comparison with FIG. 22, the packet forwarding control logic can also include path calculation module 2203 and entry generation module 2204. Wherein, path calculation module 2203 can calculate the packet forwarding path from the ingress port to the destination port in the stack forwarding table according to a preset rule based on the stack topology information of the PE stack system. Entry generation module 2204 can determine the local ports passed by the packet forwarding path and generate the local forwarding entry based on the local ports.

In another example, path calculation module 2203 can calculate the packet forwarding path according to an ingress port through which the packet enters the PE stack system and the destination port in the stack forwarding entry, wherein, the packet forwarding path is used for forwarding the packet from the ingress port to the destination port. When determining the local port passed by the packet forwarding path, entry generation module 2204 may acquire the local ingress port for receiving the packet and the local egress port used for transmitting the packet, which are passed by the packet forwarding path.

In another example, entry generation module 2204 may include port calculation unit 2301 and port selection unit 2302. When the destination port in the stack forwarding entry is a trunk port, port calculation unit 2301 may calculate the paths from the ingress port in the stack forwarding entry to each port of the trunk port respectively. And port calculation unit 2301 may determine the local ingress port for receiving the packet, the first local port as part of the truck port, and the second local port passed by to reach part of the trunk port which is located at a far end PE device according to the paths. When determining that the second local port is different from the local ingress port, port selection unit 2302 can take the first local port and the second local port as the local egress port. When determining the second local port is identical to the local ingress port, port selection unit 2302 can take the first local port as the local egress port.

In another example, entry generation module 2204 may also include blocking algorithm unit 2303. When the packet is a multicast packet, blocking algorithm unit 2303 can generate a local block port for blocking loop flow based on the blocking algorithm of the stack multicast, and delete the local block port from the local egress port in the local forwarding entry.

A PE device with the above structure can perform packet forwarding based on the local forwarding entry, and can transform the stack forwarding entry into the local forwarding entry, which causes the PE device independent from tag-encapsulation, and improves the flexibility of choosing a PE device from a PE stack system.

The skilled in the art can clearly understand that, for the convenience and concision of description, the concrete working process of every module mentioned above can refer to the corresponding process in the previous method illustration, needless to repeat here.

If the above functions of the packet forwarding control logic are achieved in the form of software function units, a machine readable storage medium storing a program which includes the software function units can be used as an independent product or for sale. It can be understood that the technical solution of the disclosure can be partly or totally achieved in the form of software product including a plurality of machine readable instructions, the software product may be stored in a storage medium, and a processing device (such as a personal computer (PC), a server, or a network device, etc.) reads out the software product to perform part or all of the blocks of the method in the examples of the disclosure. And the above-mentioned storage medium may include: USB flash disk, removable hard disk, read-only memory (ROM), random access memory (RAM), magnetic disk or optic disk and other types of storage medium storing program code.

The foregoing disclosure is merely illustrative of preferred embodiments of the disclosure but is not intended to limit the disclosure, and any modifications, equivalent substitutions, adaptations, thereof made without departing from the spirit and scope of the disclosure shall be encompassed in the claimed scope of the appended claims.

1. A method for forwarding packet, including:
receiving, by a port extender (PE) device within a PE stack system, a packet from a local ingress port of the PE device;
determining, by the PE device, a local egress port corresponding to the local ingress port by looking up a local forwarding entry according to the local ingress port;
forwarding, by the PE device, the packet via the local egress port.

2. The method according to claim 1, further including:
adding, by the PE device, an extension channel identifier in the packet in a case that the local ingress port is a non-stack port.

3. The method according to claim 2, wherein, when the local ingress port is a stack port, said looking up the local forwarding entry according to the local ingress port, including:
looking up, by the PE device, the local forwarding entry according to the local ingress port and an extension channel identifier carried in the packet, so as to determine the local egress port corresponding to the local ingress port and the extension channel identifier.

4. The method according to claim 1, before receiving the packet from the local ingress port of the PE device, the method further including:
determining, by the PE device, a packet forwarding path from an ingress port to a destination port in a stack forwarding entry by performing a calculation according to a preset rule and in line with stack topology information of the PE stack system, and
generating, by the PE device, the local forwarding entry based on local ports passed by the packet forwarding path.

5. The method according to claim 4, wherein,
said performing the calculation according to the preset rule and in line with the stack topology information of the PE stack system, including:
calculating, by the PE device, the packet forwarding path according to an ingress port through which the packet enters the PE stack system and the destination port in the stack forwarding entry, wherein, the packet forwarding path is used for forwarding the packet from the ingress port to the destination port;
said generating the local forwarding entry based on local ports passed by the packet forwarding path, including:
determining, by the PE device, a local ingress port for receiving a packet and a local egress port for transmitting the packet which are passed by the packet forwarding path, and
generating, by the PE device, the local forwarding entry according to the determined local ingress port and local egress port.

6. The method according to claim 4, wherein, when the destination port in the stack forwarding entry is a trunk port,
said performing the calculation according to the preset rule and in line with the stack topology information of the PE stack system, including:
calculating, by the PE device, paths from the ingress port in the stack forwarding entry arriving at each port of the trunk port respectively, and
said generating the local forwarding entry based on local ports passed by the packet forwarding path, including:
determining, by the PE device, according to the paths, the local ingress port for receiving the packet, a first local port as part of the trunk port, and a second local port passed by to reach part of the trunk port which is located at a far end PE device;
determining, by the PE device, the first local port and the second local port as the local egress port, when the second local port and the local ingress port are different;
determining, by the PE device, the first local port as the local egress port, when the second local port and the local ingress port are identical;
generating, by the PE device, the local forwarding entry on the basis of the determined local ingress port and local egress port.

7. The method according to claim 4, after generating the local forwarding entry based on the local ports passed by the packet forwarding path, the method further including:
generating, by the PE device, a local block port for blocking loop flow according to a blocking algorithm of stack multicast in case that the packet is a multicast packet, and
deleting, by the PE device, the local block port from the local egress port in the local forwarding entry.

8. A port extender (PE) device including a processor and a non-transitory storage medium for storing machine executable instructions corresponding to a packet forwarding control logic, and by executing the machine executable instructions, the processor is caused to:
receive a packet from a local ingress port of the PE device;
determine a local egress port corresponding to the local ingress port by looking up a local forwarding entry according to the local ingress port;
forward the packet via the local egress port.

9. The port extender according to claim 8, the machine executable instructions further cause the processor to:
add an extension channel identifier in the packet, in a case that the local ingress port is a non-stack port.

10. The port extender according to claim 9, wherein, when the local ingress port is a stack port, the machine executable instructions further cause the processor to:
look up the local forwarding entry according to the local ingress port and an extension channel identifier carried in the packet, so as to determine the local egress port corresponding to the local ingress port and the extension channel identifier.

11. The port extender according to claim 8, wherein, before receiving the packet from the local ingress port of the PE device, the machine executable instructions further cause the processor to:
determine a packet forwarding path from an ingress port to a destination port in a stack forwarding entry by performing a calculation according to a preset rule and in line with stack topology information of a PE stack system, wherein the PE device is located in the PE stack system, and
generate the local forwarding entry based on local ports passed by the packet forwarding path.

12. The port extender according to claim 11, wherein,
when performing the calculation according to the preset rule and in line with the stack topology information of the PE stack system, the machine executable instructions further cause the processor to:
calculate the packet forwarding path according to an ingress port through which the packet enters the PE stack system and the destination port in the stack forwarding entry, wherein, the packet forwarding path is used for forwarding the packet from the ingress port to the destination port;
when generating the local forwarding entry based on local ports passed by the packet forwarding path, the machine executable instructions further cause the processor to:
determine a local ingress port for receiving a packet and a local egress port for transmitting the packet which are passed by the packet forwarding path, and
generate the local forwarding entry according to the determined local ingress port and local egress port.

13. The PE device according to claim 11, wherein, in case that the destination port in the stack forwarding entry is a trunk port,
when performing the calculation according to the preset rule and in line with the stack topology information of the PE stack system, the machine executable instructions further cause the processor to:
calculate paths from the ingress port in the stack forwarding entry arriving at each port of the trunk port respectively, and
when generating the local forwarding entry based on local ports passed by the packet forwarding path, the machine executable instructions further cause the processor to:
determine the local ingress port for receiving the packet, a first local port as part of the trunk port, and a second local port passed by to reach part of the trunk port which is located at a far end PE device, according to the paths;
determine the first local port and the second local port as the local egress port, when the second local port and the local ingress port are different;
determine the first local port as the local egress port, when the second local port and the local ingress port are identical;
generate the local forwarding entry on the basis of the determined local ingress port and local egress port.

14. The PE device according to claim 11, wherein, after generating the local forwarding entry based on the local ports passed by the packet forwarding path, the machine executable instructions further cause the processor to:
generate a local block port for blocking loop flow according to a blocking algorithm of stack multicast in case that the packet is a multicast packet, and
delete the local block port from the local egress port in the local forwarding entry.
